(19) United States
(12) Patent Application Publication
(10) Pub. No.: US 2007/0123271 A1
(43) Pub. Date: May 31, 2007

(54) Cellular phone tracking scope

(76) Inventor: Richard Dickinson, Seattle, WA (US)

Correspondence Address: MANELLI DENISON & SELTER PLLC, 7th Floor, 2000 M Street, N.W., Washington, DC, 20036-3307, US

(21) Appl. No.: 11/506,830

(22) Filed: Aug. 21, 2006

Related U.S. Application Data
(60) Provisional application No. 60/711,434, filed on Aug. 26, 2005.

(51) Int. Cl. H04Q 7/20

(52) U.S. Cl. 455/456.1

(57) ABSTRACT

A cellular phone tracking scope tracks and visually maps the location and movement history of cellular phones in one or more cellular networks in a region of interest. The tracked cellular phones include detection and tracking of the location (latitude/longitude) of those that are not in use. With proper authorization, specific telephone numbers may be tapped, providing the ability to track an entire universe of cell phones by simultaneously displaying all phones within a specific boundary on a “tracking scope” similar to a radar scope. The tracked cellular phones that are displayed may be filtered, e.g., to show which cellular phones are those of a friend, which are those of a foe, and/or which are those of an unknown person or device. The location and phone number of desired phones can be displayed.

This application claims priority from U.S. Provisional Application No. 60/711,434 to Dickinson entitled “RF Tracking Scope By Tracking Wireless Devices”, the entirety of which is expressly incorporated herein by reference.

### BACKGROUND OF THE INVENTION

1. Field of the Invention

This invention relates generally to wireless telecommunication. More particularly, it relates to the use of location based technologies in the wireless field to provide real time tracking of wireless handsets.

2. Background of Related Art

On the modern battlefield, combatants (especially non-professional or terrorist forces) often communicate using existing cellular telephone networks. This invention facilitates the tracking of enemy combatants by pinpointing the locations of their cell phones. This invention can also be used to track and identify friendly forces.

Currently, the latitude and longitude of cell phones can be determined using a variety of techniques. Typically, military intelligence units listen for specific telephones and determine the location of one phone at a time when that phone is actually in use. Some techniques are able to locate phones even when they are powered on, but not necessarily in use. Heretofore, cellular location techniques have been limited to single phones at a time. Locations are recorded via written latitude and longitude notations.

Disadvantages of the current solution are that only one phone is tracked at a time, it provides no information regarding the relative position of one phone to another, and it requires the foreknowledge of a specific phone number to be located.

### SUMMARY OF THE INVENTION

In accordance with the principles of the present invention, a cellular phone tracking scope comprises a location probe, in communication with a cellular network, to detect a presence of cellular phones within a given area. A location manager requests a location for all cellular phones present within the given area. A mapping, filtering and display module maps the present cellular phones, subject to a filtering to a desired subset of the cellular phones present if desired.

A method of tracking a plurality of cellular phones in a given region in accordance with another aspect of the present invention comprises detecting a presence of cellular phones within a given area. A location for each of the detected present cellular phones within the given area is requested. The detected present cellular phones are filtered to a desired subset of the detected present cellular phones as desired. A location of the detected present cellular phones is mapped and displayed, subject to the filtering.

### BRIEF DESCRIPTION OF THE DRAWINGS

Features and advantages of the present invention will become apparent to those skilled in the art from the following description with reference to the drawings:

FIG. 1 depicts the elements of a cellular phone tracking scope using an exemplary location platform logical architecture, in accordance with the principles of the present invention.

FIG. 2 shows an exemplary screen shot of Users' locations, in accordance with the principles of the present invention.

FIG. 3 shows an exemplary screen shot of users' detailed status, in accordance with the principles of the present invention.

FIG. 4 shows an exemplary screen shot of user location history, in accordance with the principles of the present invention.

### DETAILED DESCRIPTION OF ILLUSTRATIVE EMBODIMENTS

In accordance with the present invention, a cellular phone tracking scope tracks and visually maps the location and movement history of cellular phones in one or more cellular networks in a region of interest. The tracked cellular phones include detection and tracking of the location (latitude/longitude) of those phones that are not in use. With proper authorization, specific telephone numbers may be tapped, providing the ability to track an entire universe of cell phones by simultaneously displaying all phones within a specific boundary on a “tracking scope” similar to a radar scope. The tracked cellular phones that are displayed may be filtered, e.g., to show which cellular phones are those of a friend, which are those of a foe, and/or which are those of an unknown person or device. The location and phone number of desired phones can be displayed. In an augmentation of the cellular phone tracking scope, with appropriate authorization, one or more displayed phones may be clicked on to direct monitoring of a conversation on that particular phone.

Using a cellular phone tracking scope, the present invention allows extensive battlefield monitoring, filtered as desired to view cellular phones mapped to a detected location for respective phones. Filtering functions may allow for display, e.g., all cellular phones in a given region, all cellular phones that are turned on in a given region, all cellular phones that are turned off in a given region, all cellular phones of known persons (e.g., pre-registered with the user of the tracking scope), etc.

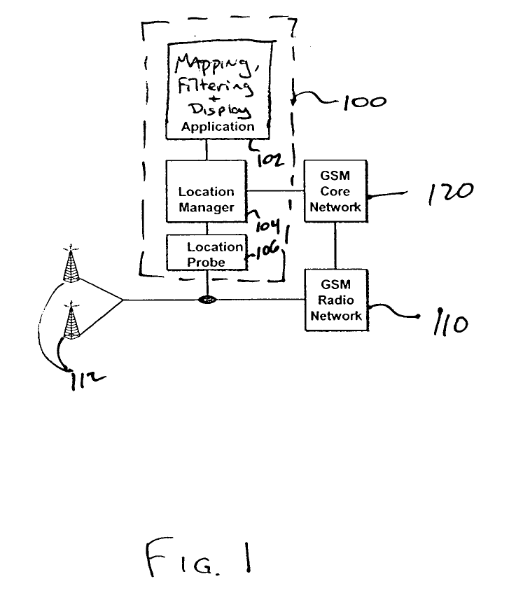

FIG. 1 depicts the elements of a cellular phone tracking scope using an exemplary location platform logical architecture, in accordance with the principles of the present invention.

In particular, as shown in FIG. 1, a cellular phone tracking scope 100 includes a mapping, filtering and display module 102, a location manager (LM) 104, and a location probe 106.

The location manager 104 is in communication with the core network of the cellular provider(s), to allow it to request and obtain location information relating to any/all cellular users of the relevant cellular network.

The location probe 106 is a passive device that monitors the signaling links on the interface between a base station controller (BSC) and a base transceiver station (BTS). The APU software executes on custom hardware. An auxiliary processing unit (APU) collects data from the traffic that is required for estimating locations of mobiles.

The location probe 106 of the cellular phone tracking scope 100 taps into, or is otherwise in communication with, the relevant cellular radio network(s) (e.g., a GSM radio network) of one or more target cellular phone providers in the region of interest, to allow detection and location of cellular phone traffic being handled by any number of cellular towers 112.

The location manager (LM) 104 calculates the location of any/all cellular devices detected by the location probe 106. The location manager 104 uses data relating to cellular devices detected by the location probe 106, together with a predicted signature database (PSD), to estimate the location of any/all cellular devices in a given region or area. The preferable location manager may be implemented on any suitable server.

One of the great breakthroughs of current cellular location technology is that is it completely passive, requiring only non-intrusive hardware installation. The number of ongoing position fixes is limited solely by the computing power of the location platform, which can be expanded indefinitely as required.

The location manager determines location by capitalizing on measurements by handsets and base stations in the cellular network. Each geographical location has a unique radio signature, based on the characteristics of the measured quantities at that position. These measurements, such as neighbor signal strengths, cell identifications and timing advance values, are used with sophisticated statistical pattern matching techniques to estimate location by correlating against a predicted signature database (PSD). The PSD is preferably built at the time of system deployment.

The predicted signature database (PSD) is built based mostly on propagation prediction models combined with limited drive test calibration. The preferred propagation prediction models use standard geographical information system (GIS) data such as terrain elevation and clutter maps. Drive test calibration is performed to tune the propagation model parameters. The drive testing is performed with standard drive test equipment using antennas that can be made unobtrusive or camouflaged.

The drive test calibration can be modified to suit the conditions in the measurement area. In a given application, typically only primary roads need be driven for calibration, with minor roads being much less required and/or desirable. The drive testing can be performed at high speed to facilitate rapid data collection. It is not necessary to stop the drive test vehicle during collection. The drive test process can be automatic (i.e., without requiring field engineers), by installing unattended collection equipment in buses, taxis or other moving vehicles. If a particular area cannot be easily calibrated, then pure propagation prediction can be used in that region.

The predicted signature database (PSD) is maintained through automatic and semi-automatic updates. If the wireless service provider makes “soft” changes, such as frequency plan or neighbor list updates, then these are handled automatically and transparently by the location manager 104. If the cellular service provider makes “hard” changes, such as new cell site additions, then the location manager 104 preferably requests calibration data from the core network 120. If drive calibration data is not available, then a prediction model is used to provide location in the area. Drive calibration can be scheduled when convenient, or avoided altogether if not possible in the region.

A mobile resource management system based on the cellular phone tracking scope can provide mapping of command central capabilities such as tracking personnel and/or vehicle locations in real-time. A web control center may be established as a command central where cell phone locations are tracked, status monitored, and instructions are sent to the field. Both a web control center and/or a mobile device client may be implemented. The mobile device client may be used for friendly personnel so as to determine their own location, receive dispatch instructions, relay status information and display routes.

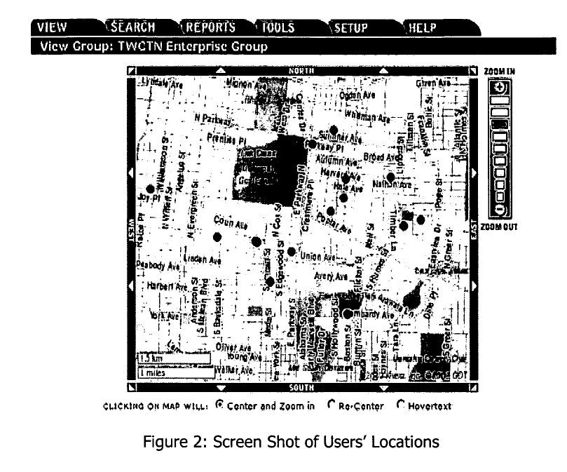

FIG. 2 shows an exemplary screen shot of Users' locations, in accordance with the principles of the present invention.

In particular, as shown in FIG. 2, the location of each detected cell phone (and in turn an associated personnel) may be represented as an icon on a detailed map displayed by the mapping, filtering, and display module 102.

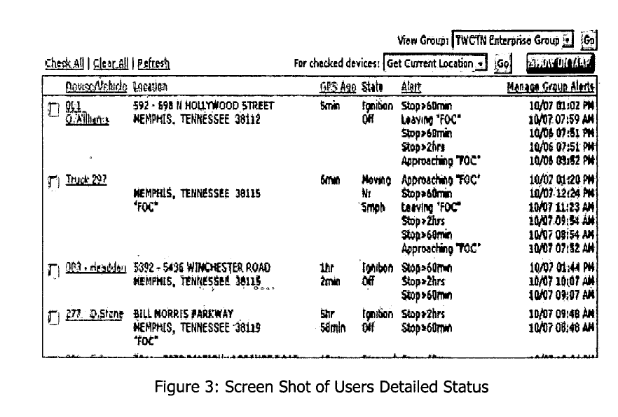

FIG. 3 shows an exemplary screen shot of users' detailed status, in accordance with the principles of the present invention.

In particular, as shown in FIG. 3, the mapping, filtering and display module 102 may also display a table listing each person's name, group, and/or current location. Preferably, all map displays support pan and zoom capabilities, and allow filtering by groups.

The mapping, filtering and display module 102 preferably includes a comprehensive administrative module that allows the definition of groups, users and roles. Users can be assigned to specific groups and global tracking settings can be defined for each user/group including frequency of location update, location accuracy, and tracking record.

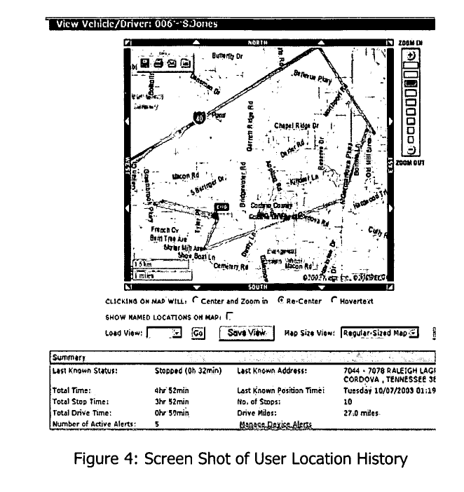

FIG. 4 shows an exemplary screen shot of user location history, in accordance with the principles of the present invention.

As shown in FIG. 4, preferably all cellular devices in the defined region are tracked on a regular, periodic basis. This tracking data, and time between location fixes, can be used to establish a movement history for any or all detected cellular phones. All, or a subset of all, cellular phone users are displayed on a visual map as required by the particular application for the cellular phone tracking scope.

The mapping, filtering and display module 102 also preferably allows command central to define geographical areas where alerts are to be generated if a user enters or leaves a designated area. Thus, monitoring of friendly and non-friendly forces is done automatically as command central is notified when any user goes outside of set boundaries or into danger areas. A user's location history (bread crumb trail) can also be seen to determine the exact course that a person followed in time, their number of stops, and/or total moving and non-moving status.

In a best case scenario, emergency calls from devices being tracked are routed to a default dispatcher, who has the equipment necessary to request and display a map via the mapping, filtering and display module 102, and who can locate the cellular phone caller on a map with high accuracy.

In a given implementation, more than 20,000 cellular phone users throughout a city can be tracked, with capability to handle up to 100,000 phones or more. Ideally, every phone on a relevant cellular network can be tracked.

Preferably, the type of mobile phone is irrelevant. Thus, the location manager 104 includes compatible communication modules and protocols to communicate with a core network of, e.g., CDMA, TDMA, GSM, etc. networks. Similarly, the location probe 106 includes communication modules and protocols to communicate with a radio network of, e.g., CDMA, TDMA, GSM, etc. networks.

In the embodiment shown in FIG. 1, the cellular phone tracking scope 100 can track any GSM phone on a network, with or without GPRS data plans. Preferably all users can be tracked on a “near-real-time” basis. A subset of any group of users can be displayed on a map in the mapping, filtering and display module 102 as required, and an emergency call can be routed to a dispatcher who locates and follows the caller on a map with high accuracy.

In a given embodiment, military ground commanders can visually track their troops in real time using the cellular phone tracking scope 100, or potential enemy forces (i.e., unknown cellular devices in a given region of a war zone) may be monitored, in much the same way that United States' Airborne Warning And Control System (AWACS) aircraft currently monitor friendly and enemy aircraft in the skies using radar locating techniques. However, whereas an AWACS aircraft uses radar to detect and locate aircraft, the cellular device tracking scope 100 uses passive tracking techniques to detect and locate cellular devices (including wireless phones, voice over Internet Protocol (VoIP) phones, GSM phones, etc.), and including cellular phones that are not in use.

Cellular locating techniques permit location updates on a very frequent basis (e.g., any number of phones every few seconds). Thus, a real time cellular phone tracking scope 100 is provided that observes not only the location, but can also store a history for each detected phone number to provide a movement history of cell phones throughout any given region or area. The length of the movement history is dependent upon the size of memory or appropriate database used to store location information for each phone detected, as well as the number of phones in the detected area.

A cellular phone tracking scope 100 in accordance with the present invention may be used by military to, e.g., track the location of friendly units. In such an application, the cellular phone tracking scope 100 preferably identifies each “blip” with appropriate information, e.g., its cell phone number, unit designation, and even the name of the soldier to whom it is assigned (if a known cellular phone). Specific displayed data can be turned on or off through a filter selection to maximize information or minimize clutter. For instance, specific military units can be tracked at platoon, company, battalion, brigade or division level. Using a cellular phone tracking scope 100, a commander can literally watch their troops move around any given area of operations where cellular traffic can be detected.

The cellular phone tracking scope 100 is also useful in emergency situations, allowing medical evacuation (medevac) units to find troops that are wounded in action, or to allow artillery units to determine the proximity of friendly troops to potential impact areas, and/or even allowing reinforcements to find troops in distress.

Within the limits of the prevailing military or civilian law, either during times of war, times of emergency, or even during peacetime, a cellular phone tracking scope 100 can be used to track civilian phones of interest. Just as an AWACS may alert friendly aircraft of the presence of unidentified and potentially hostile aircraft, a cellular phone tracking scope 100 has the ability to alert ground commanders of a mapped location of suspicious civilian cell phones. For instance, unknown cell phones that appear frequently in a region known to harbor terrorist bombings, or those of persons that appear to be shadowing, or following American or Allied troops, can not only be detected and identified, but can also be secretly monitored, turned off, or even attacked.

Recent advances in cellular location technologies permit the detection of a location of all activated cell phones that are not necessarily in use (i.e., all wireless cellular devices that are in an idle or standby mode, rather than in an active call mode). The cellular phone tracking scope 100, supported by mapping and location expertise, can be sized to track as many as thousands, or even hundreds of thousands of cell phones, in a real time basis, allowing appropriate authorities to watch the movement of users of cell phones in much the same way that air traffic controllers watch the movement of airplanes.

Such functionality facilitates a number of tactical capabilities: (1) routine troop movement, monitoring and control; (2) tracking of enemy mobile phones; and (3) E911 tracking.

With respect to routine troop movement, monitoring and control, specific mobile phone numbers are designated by group, allowing commanders to follow the real time movement of their specific units throughout an area of operations. For example, a commander of the Third Infantry Division can follow each of their troops' mobile phones, and the commander of the 101^{st} Airborne can follow their personnel's mobile phones. The group commander can follow all phones, or selected units.

With ease such as the click of a mouse, a commander can click on a specific crosshair and display the phone number, unit designation, and/or name of the soldier to whom the phone is issued.

Enemy mobile phones can be tracked as well. For instance, in addition to monitoring the location of friendly troops, the location of all civilian cell phones can be tracked. As civilian phones are located in close proximity of military phones, several options are available.

As examples, civilian phones can be selectively deactivated in the vicinity of friendly phones to preclude enemy tactical coordination via cell phone. Also, civilian phones can be dialed to alert innocent civilians of impending operations or airstrikes in their area. Specific civilian phones can be monitored to see if they are collaborating with the enemy. Suspicious civilian phones can be identified. Such phones might include any phone located in an abandoned vehicle, indicating a potential trigger for an IED. These phones can be dialed (e.g., to set off a bomb prematurely) or deactivated. Other suspicious phones might be those that regularly turn up in the vicinity of enemy attacks, or those that trail friendly troop movements. These phones could be monitored or simply destroyed.

The cellular phone tracking scope 100 can be implemented to track all E911 calls in a given region. For instance, in an emergency, a 911 call can be routed directly to a designated public safety answering point (PSAP). Emergency calls can be limited to specific phones identified by authorities, so that only friendly military phones are routed. The PSAP dispatcher can enter the cell phone number of a caller, causing the cross hair on a relevant map to commence flashing, along with the name, unit, phone number and/or latitude/longitude.

Significant benefits arise from the present invention. For instance, in a peacetime environment, a cellular phone tracking scope 100 can be used for extremely targeted advertising by determining the location of a specific phone, and then initiating a verbal announcement or visual display directed specifically at the owner of that cell phone whenever the phone is determined to be in the vicinity of the announcement or visual display.

While the invention has been described with reference to the exemplary embodiments thereof, those skilled in the art will be able to make various modifications to the described embodiments of the invention without departing from the true spirit and scope of the invention.

What is claimed is:

1. A cellular phone tracking scope, comprising:
a location probe, in communication with a cellular network, to detect a presence of cellular phones within a given area;
a location manager to request a location for each cellular phone present within said given area; and
a mapping, filtering and display module, to map said present cellular phones, subject to a filtering to a desired subset of said cellular phones present if desired.

2. The cellular phone tracking scope according to claim 1, wherein:
said given area is determined based on the location of specific radio towers used by said cellular network.

3. The cellular phone tracking scope according to claim 1, wherein:
said cellular network is a GSM wireless network.

4. The cellular phone tracking scope according to claim 1, wherein:
said cellular network is a CDMA wireless network.

5. A cellular phone tracking scope, comprising:
means for probing a cellular network for detecting a presence of cellular phones within a given area;
location management means for requesting a location for said detected present cellular phones within said given area; and
a mapping, filtering and display module, to map a location of said detected present cellular phones, subject to a filtering of said detected present cellular phones to a desired subset of said detected present cellular phones as desired.

6. The cellular phone tracking scope according to claim 5, wherein:
said given area is determined based on the location of specific radio towers used by said cellular network.

7. The cellular phone tracking scope according to claim 5, wherein:
said cellular network is a GSM wireless network.

8. The cellular phone tracking scope according to claim 5, wherein:
said cellular network is a CDMA wireless network.

9. A method of tracking a plurality of cellular phones in a given region, comprising:
detecting a presence of cellular phones within a given area;
requesting a location for each of said detected present cellular phones within said given area;
filtering said detected present cellular phones to a desired subset of said detected present cellular phones as desired; and
mapping and displaying a location of said detected present cellular phones, subject to said filtering.
